(19) United States
(12) Patent Application Publication
(10) Pub. No.: US 2004/0198324 A1
(43) Pub. Date: Oct. 7, 2004

(54) Mobile communication device with a repeated reading function

(76) Inventors: Cheng-Shing Lai, Taipei (TW); Wan-Jun Liu, NanJing (CN)

Correspondence Address: RABIN & Berdo, PC, 1101 14TH STREET, NW, SUITE 500, WASHINGTON, DC, 20005, US

(21) Appl. No.: 10/158,882

(22) Filed: Jun. 3, 2002

(51) Int. Cl. H04M 3/00

(52) U.S. Cl. 455/412.1; 455/418; 455/414.1

(57) ABSTRACT

A mobile communication device is disclosed, wherein the user can download a file via a connection to the Internet, so that the file can be played with repeated playing. The mobile communication device comprises a network connection unit, a storage unit, a playing unit, and a repeated reading unit. The network connection unit is used to connect to the Internet and to download a file, such as an MP3 file, via the server. The storage unit is coupled to the network connection unit, and is used to store the MP3 file. The playing unit is coupled to the storage unit and is used to decompress the MP3 file before playing. The repeated reading unit is also coupled with the playing unit, and is used to control the playing unit for performing the repeated playing function.

### BACKGROUND OF THE INVENTION

1. Field of Invention

The present invention relates to a mobile communication device. More particularly, the present invention relates to a mobile communication device with a repeated reading unit.

2. Description of Related Art

Nowadays, with the communications technology having been greatly developed, the mobile communication device has become an indispensable part in our daily life. The properties of light weight and compactness have made the device highly portable, allowing the modem people to communicate with each other from anywhere and at anytime. In addition, the Internet and the wireless communication technology have been developed with applications and thereby further allow the user to connect to the Internet via the wireless communication module of the mobile communication device. In this manner, it can be very convenient download the information from a web site on the Internet.

In addition, when the various information in mixed media have inundated the media life, the language has become the one learning course that is necessary to be taken for the modem people. Of course, the user can use a usual language-learning machine and a language-learning tape to learn the desired language. With the function of repeated reading for the language-learning machine, the user can repeatedly listen to the language-learning tape at desired portions, so as to enhance the learning effect.

However, the language-learning machine is usually equipped with a magnetic tape and a numeric piece in combination. In addition, frequent use and humidity could cause the magnetic tape to be easily damaged, and then it would be necessary to buy another new magnetic tape. Also, the language-learning machine usually is very heavy and not portable. Thus, the user cannot carry it, as with the mobile communication device, and loses an opportunity to learn and enhance the skill. However, it has been the trend that the electronic device become more portable for convenient usage and that the information is in the digital data format. Following this trend, it will be a rather practical issue about how to allow the user to directly use the mobile communication device to perform the equivalent function, such as those of the language-learning machine.

### SUMMARY OF THE INVENTION

It is therefore an object of the present invention to provide a mobile communication device with a repeated reading unit, which can play the digitized audio data format, so that the issue of attrition on the magnetic tape can be solved. In this manner, the user can use the mobile communication device at anywhere and anytime to perform the repeated reading function. In addition, it can even be connected to the Internet, so as to download the desired MP3 files. Thus, the cost can be greatly reduced.

In accordance with the objective of the present invention, a mobile communication device is provided for the user to download the MP3 file, from the Internet, so that the MP3 file can be played once or repeatedly. The mobile communication device comprises a network connection unit, a storage unit, a playing unit, and a repeated reading unit. The network connection unit is used to connect to the Internet and to download the MP3 file via the server. The storage unit is coupled to the network connection unit, and is used to store the MP3 file. The playing unit is coupled to the storage unit and is used to decompress the MP3 file, so that the MP3 file can be played. The repeated reading unit is also coupled with the playing unit, and is used to control the playing unit for performing the repeated playing.

### BRIEF DESCRIPTION OF THE DRAWINGS

The accompanying drawings are included to provide a further understanding of the invention, and are incorporated in and constitute a part of this specification. The drawings illustrate the embodiments of the invention and, together with the detailed description, serve to explain the principles of the invention. In the drawings,

FIG. 1 is a block diagram, schematically illustrating a system architecture for the mobile communication device, the computer, the Internet, and the server, according to one preferred embodiment of the present invention;

FIG. 2 is a process flow diagram, schematically illustrating the procedure for the mobile communication device to download the MP3 file, according to one preferred embodiment of the present invention;

FIG. 3 is a process flow diagram, schematically illustrating the procedure for the mobile communication device to perform the repeated reading procedure in word sentence, according to one preferred embodiment of the present invention;

FIG. 4 is a process flow diagram, schematically illustrating the procedure for the mobile communication device to perform the repeated reading procedure in time period, according to one preferred embodiment of the present invention; and

FIG. 5 is a process flow diagram, schematically illustrating the procedure for the mobile communication device to perform a comparison and following reading procedure in match function, according to one preferred embodiment of the present invention.

### DESCRIPTION OF THE PREFERRED EMBODIMENTS

The disclosed invention provides a design for a mobile communication device, which allows a user to download an MPEG layer 3 (MP3) file from a server via a connection to the Internet. The present invention allows the user to perform the repeated reading action on the MP3 file at anywhere and anytime, in a very convenient way. The invention reads the MP3 file in a digitized data format, so that it can avoid the issue of attrition of the magnetic tape, which is encountered by the conventional language-learning machine. The user can even download MP3 files via the Internet, so as to reduce cost. In addition, the present invention can also play a file in an audio format with a high compression ratio by a random manner for selecting the playing time period and can implement the repeated reading in any selected time period. At the same time, the data in the audio format with highly compressed ratio can be decompressed and stored in the mobile communication device, so that it is convenient for the mobile communication device to play repeatedly. The practical application of the present invention is described by example of a preferred embodiment with the accompanying drawings in the following.

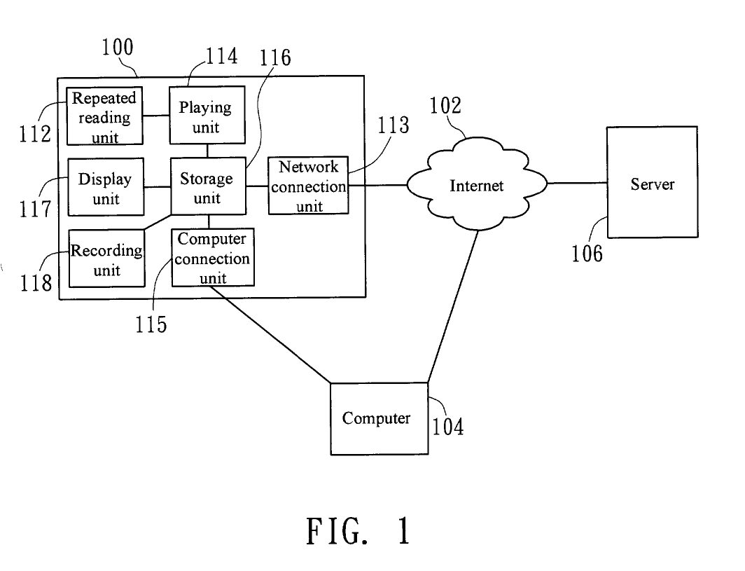

Referring to FIG. 1, it is a block diagram, schematically illustrating a system architecture for the mobile communication device, the computer, the Internet, and the server, according to one preferred embodiment of the present invention. As shown in FIG. 1, a mobile communication device 100 is directly connected to the Internet 102. If, the mobile communication device 100 is coupled to the computer 104 via a synchronous connection manner, then the computer 104 is connected to the Internet 102, so that the mobile communication device 100 can be connected to a server 106 via the Internet 102, in order to download a MP3 file, such as the information for the language learning, from the server 106.

The mobile communication device 100 comprises a repeated reading unit 112, a network connection unit 113, a playing unit 114, a computer connection unit 115, a storage unit 116, a displaying unit 117, and a voice recording unit 118. The network connection unit 113 is used to connect to the Internet 102 and to download the original text file and the MP3 file from the server 106. The voice recording unit 118 is used to record and export a recorded audio file. The storage unit 116 is coupled to the network connection unit 113 and the voice recording unit 118, so as to store the MP3 file, the original text file related to the MP3 file, and the recorded audio file.

In addition, the playing unit 114 is coupled to the storage unit 116, and is used to control the compression ratio by using the sampling rate, so that the MP3 file and the recorded audio file can be decompressed for the playing. The repeated reading unit 112 is coupled to the playing unit 114, and is used to control the playing unit 114 for repeatedly playing the selected MP3 file and the recorded audio file. Further still, the playing unit 117 is coupled to the storage unit 116, and is used to display the text information of the MP3 file, and the starting time point for playing with respect to the text information of the MP3 file.

As mentioned earlier, the mobile communication device 100 retrieves the MP3 file from the Internet 102, wherein the device 100 can uses the wireless communication protocol of the general packet radio service (GPRS) to connect to the Internet 102. Additionally, the computer connection unit 115 is used to be coupled to the computer 104 via a series connection port, an infrared connection port, or an universal series bus (USB) connection port, wherein, the computer 104 can be installed with a synchronous software (not shown in the drawing), so as to transmit the MP3 file downloaded from the server 106 in the Internet 102 to the mobile communication device 100 in the synchronous manner. This is very convenient.

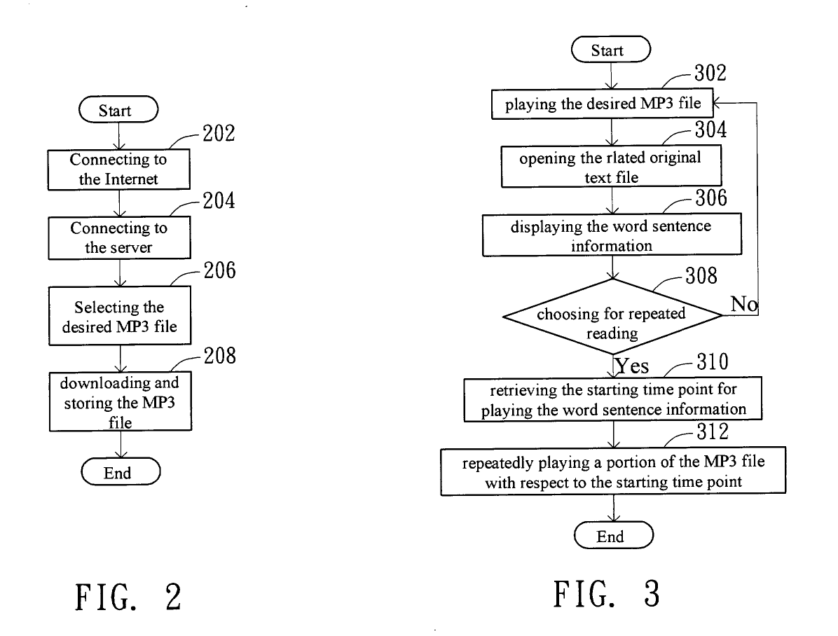

Also, referring to FIG. 2, it is a process flow diagram, schematically illustrating the procedure for the mobile communication device to download the MP3 file, according to one preferred embodiment of the present invention. As shown in FIG. 2 and FIG. 1, first in the step 202, the mobile communication device 100 is turned on and connected to the Internet 102, wherein, the mobile communication device 100 is connected to the Internet 102 via the network connection unit. Alternatively, the mobile communication device 100 is coupled to the computer 104 via a computer connection unit 115, and then the computer 104 is connected to the Internet 102. It should be noted that the MP3 file can also be obtained from a disk in a hard disk drive or an optical disc in the optical disc drive of the computer 104.

Then, in the step 204, connection to the server 106 of the Internet 102 is completed and the server 106 has a number of MP3 files that can be downloaded by the user to be used as the language-learning course. Next, in the step 206, a desired MP3 file is selected. In the step 208, the selected MP3 file and related text file of the server 106 are downloaded and stored into the storage unit 116. Then, the user can perform the function of repeated reading in the mobile communication device 100. Of course, the MP3 file that was downloaded by the present invention is suitable for use in learning language. Furthermore, the data structure of the combination of the audio file and written file is different from that of a conventional MP3 file.

Next, referring to FIG. 3, it is a process flow diagram, schematically illustrating the procedure for the mobile communication device to perform the repeated reading procedure in word sentence, according to one preferred embodiment of the present invention. As shown in FIG. 3, the step of 302 is first performed for playing the desired MP3 files, such as the language-learning course, selected using the mobile communication device 100. Of course, it is necessary for the mobile communication device 100 to decompress and play the MP3 file, which is originally stored in the storage unit 116, via the playing unit 114.

In the step 304, the original text file related to the MP3 file to be played is opened. The original text file includes information about the word sentences, and the starting time points for playing them with respect to the information of the word sentences on MP3 file. Then, the procedure enters the step 306, in which the displaying unit 117 displays the word sentences and the relative starting time points for playing them.

Then, in the step 308, it is judged whether or not the user has selected the word sentence for being repeatedly read. If it is, then the procedure enters the step 310, in which the repeated reading unit 112 retrieves the starting time points for playing them with respect to the information of the word sentences on MP3 file, so as to perform the repeated reading action on the word sentences. Otherwise, the playing unit 114 will continue to play through the MP3 file.

Next, the procedure enters the step 312, in which the playing unit 114 stops playing the MP3 file and the repeated reading unit 112 controls the playing unit 114, according to the retrieved starting playing time points, so as to repeatedly play the portion of the MP3 file related to the starting playing time points.

Of course, the user can make use of the press button to cancel current the operation on the mobile communication device 100 about the action of repeated reading the word sentences and continuously listen to the MP3 file or repeatedly reading at another time period for the word sentences. In addition, while the mobile communication device 100 is under the operation to play the MP3 file or perform the repeated reading action on the word sentence, the mobile communication device 100 can monitor whether or not an incoming call or an incoming message has occurred. Additionally, the current status is properly controlled.

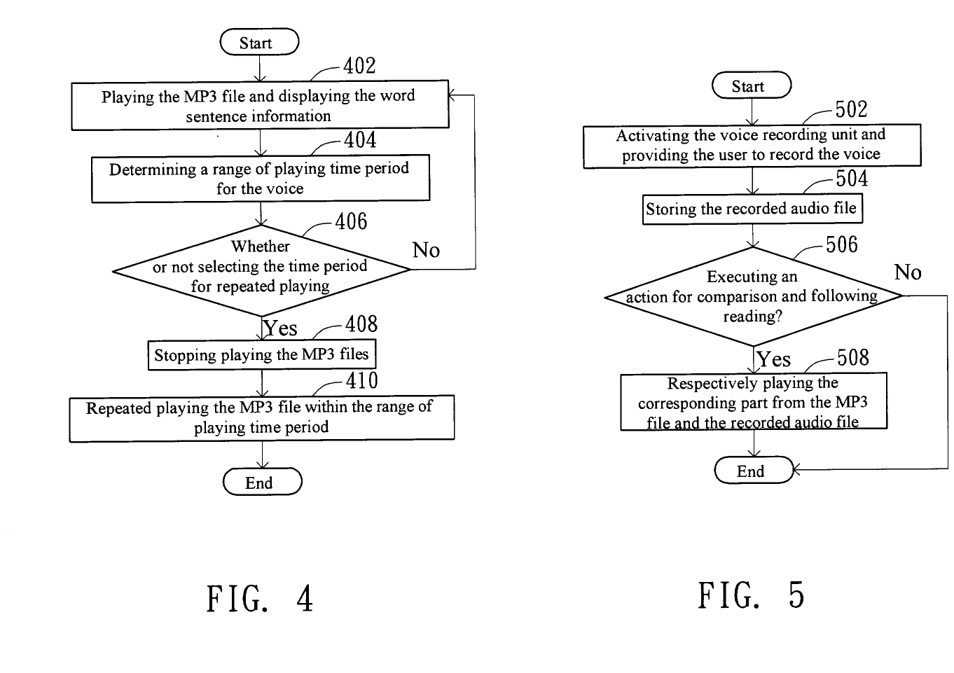

Referring to FIG. 4, it is a process flow diagram, schematically illustrating the procedure for the mobile communication device to perform the repeated reading procedure in time period, according to one preferred embodiment of the present invention. As shown in both FIG. 1 and FIG. 4, the procedure first enters the step 402, in which the MP3 file is played and the displaying unit 117 displays the information of the word sentences that are now being played. Then, the procedure enters the step 404, in which a range of playing time period for the voice is set and the decompressed information of the word sentences is stored in the repeated reading unit 112. For example, the range of the playing time period is set to be 1-100 seconds (sec). Next, in the step 406, it is judged whether or not the user has selected the time period for repeated playing. If not, then the mobile communication device 100 continuously plays through the MP3 file. Otherwise, then the procedure enters the step 408, in which it stops playing the MP3 file. And then, the procedure enters the step 410, in which the repeated reading unit 112, according to the range of playing time period for the voice, controls the displaying unit 114 to repeatedly play the related portion of the MP3 file stored in the repeated reading unit 112.

Of course, the user can make use of the press button to cancel current the operation on the mobile communication device 100 about the action of repeated reading procedure in time period and continuously listen to the MP3 file or repeatedly reading at another time period for the word sentences. Similarly, as in the previous example, while the mobile communication device 100 is under the operation to play the MP3 file or perform the repeated reading action in time period, the mobile communication device 100 can monitor whether or not an incoming call or an incoming message has occurred. Also and, the current status is properly controlled.

Referring to FIG. 5, it a process flow diagram, schematically illustrating the procedure for the mobile communication device to perform a comparison and following reading procedure, according to one preferred embodiment of the present invention. As shown in both FIG. 1 and FIG. 5, the procedure first enters the step 502, in which if the play unit 114 is playing the MP3 file and the user intends to make a voice recording, then the user can activate the voice recording unit 118, and the playing unit 114 would stop playing the MP3 file. In this manner, it provides the voice recording operation and exports a recorded audio file to the storage unit 116. Then, in the step 504, the recorded audio file is stored in the storage unit 116.

Next, in the step 506, it is judged whether or not the user has chosen to execute the comparison and following reading procedure, so as to compare the reading voice and the recording to determine a match. If it is not, then the procedure goes to an end. Otherwise, the procedure enters the step 508, in which the two voice channels respectively play the related part from the MP3 file and the recorded audio file, so that the user can compare them for further learning. It is very convenient.

Of course, the user can make use of the press button on the mobile communication device 100 to cancel the current operation of the comparison and following reading procedure and to continuously listen to the MP3 file or the other functions. In addition, while the mobile communication device 100 is under the operation to play the MP3 file or perform the comparison and following reading function, the mobile communication device 100 can monitor whether or not an incoming call or an incoming message has occurred. Also, the current status is properly controlled.

In summary, the preferred embodiment of the present invention has disclosed, wherein a mobile communication device with a repeated reading unit and a method for repeated reading have the following advantages:

1. The said device and method use audio data in a digital format, so that the issue of attrition on the magnetic tape of the conventional device is avoided.

2. The present invention is portable, so that the user can use the mobile communication device at anytime and anywhere for performing the repeated reading function.

3. The mobile communication device can be connected to the Internet, so as to download the desired MP3 file, and reduce the operation cost.

It will be apparent to those skilled in the art that various modifications and variations can be made to the structure of the present invention without departing from the scope or spirit of the invention. In view of the foregoing, it is intended that the present invention covers such modifications and variations of this invention provided they fall within the scope of the following claims and their equivalents.

What is claimed is:

1. A mobile communication device, for providing for a user to connect to a server via an Internet and then to download a MPEG layer 3 (MP3) file, so as to perform an operation on repeatedly reading the MP3 file, the mobile communication device comprising:
a network connection unit, for connecting to the Internet and to download the MP3 file from the server;
a storage unit, coupled to the network connection unit and used for storing the MP3 file;
a playing unit, coupled to the storage unit and used for decompressing the MP3 file, so as to be capable of playing the MP3 file; and
a repeated reading unit, coupled to the playing unit and used for controlling the playing unit to perform a repeated playing.

2. The mobile communication device according to claim 1, wherein the mobile communication device further comprises a method to download the MP3 file, the method to download the MP3 file comprising:
connecting to the Internet;
connecting to the server of the Internet, wherein the server comprises the MP3 file; and
selecting the MP3 file and downloading the MP3 file.

3. The mobile communication device according to claim 2, wherein the mobile communication device is using a general packet radio service (GPRS) to connect to the Internet.

4. The mobile communication device according to claim 1, further comprising:
a computer connection unit, coupled to the storage unit, for connecting to a computer, and downloading the MP3 file from the computer and store into the storage unit.

5. The mobile communication device according to claim 4, wherein the computer comprises a synchronous software, so as to download the MP3 file via the computer, and synchronously transmit the MP3 file to the mobile communication device.

6. The mobile communication device according to claim 4, wherein the computer connection unit is coupled to the computer by a series connection port

7. The mobile communication device according to claim 4, wherein the computer connection unit is coupled to the computer by an infrared connection port.

8. The mobile communication device according to claim 4, wherein the computer connection unit is coupled to the computer by a universal series bus (USB) connection port.

9. The mobile communication device according to claim 1, wherein the mobile communication device downloads an original text file, with respect to the MP3 file, from the server, and the original text file comprises the text information, and the starting time point for playing with respect to the text information on the MP3 file, wherein the mobile communication device further comprises:
a displaying unit, coupled to the storage unit, for displaying the text information and the starting time points for playing.

10. The mobile communication device according to claim 9, wherein the mobile communication device further comprises a method for repeated reading word sentences, the method for repeated reading the word sentences comprising:
playing the MP3 file;
opening the original text file;
displaying the word sentence information with respect to the portion, being played, of the MP3 file; and
determining whether or not selecting a portion of word sentences to repeatedly read, if it is, retrieving a starting playing time point for the word sentence information, and repeatedly playing a portion of the MP3 file with respect to the word sentence information, according to the starting playing time point, otherwise continuously playing the MP3 file.

11. The mobile communication device according to claim 10, wherein the repeated reading unit retrieves the starting playing time point for the word sentence information, and repeatedly plays a portion of the MP3 file with respect to the word sentence information, according to the starting playing time point.

12. The mobile communication device according to claim 9, wherein the mobile communication device further comprises a method for repeatedly reading in time period, the method for repeatedly reading in time comprises:
playing the MP3 file, and displaying a word sentence information with respect to the portion, being played, of the MP3 file in playing;
determining a range of playing time period for voice and storing the word sentence information with respect to the range of playing time period for voice; and
determining whether or not selecting a time period for repeated playing, if it is, the method stopping playing the MP3 file and repeatedly plays word sentence information within the range of playing time period for voice, otherwise, continuously playing the MP3 file.

13. The mobile communication device according to claim 12, wherein the range of playing time period for voice is set as 1-100 second, and the range of playing time period for voice is stored in the repeatedly reading unit.

14. The mobile communication device according to claim 13, wherein the repeatedly reading unit controls the playing unit, according to the range of playing time period, to repeatedly play the word sentence information within the range of playing time period.

15. The mobile communication device according to claim 1, further comprising:
a voice recording unit, coupled to the storage unit, for providing the user to record and exporting a recorded audio file to the storage unit.

16. The mobile communication device according to claim 15, wherein the mobile communication device further comprises a method of comparison and following reading, the method of comparison and following reading comprising:
playing the MP3 file;
choosing to record voice and stopping playing the MP3 file;
generating the recorded audio file and storing the recorded audio file; and
determining whether or not to execute an action for comparison and following reading, if it is, then respectively playing a related portion of the MP3 file and the recorded audio file, otherwise ending the method.
